(19) United States
(12) Patent Application Publication
(10) Pub. No.: US 2012/0079371 A1
(43) Pub. Date: Mar. 29, 2012

(54) SYSTEM AND METHOD FOR PROCESSING TEXT IN ELECTRONIC DEVICE

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/175,088

(22) Filed: Jul. 1, 2011

(30) Foreign Application Priority Data
Sep. 29, 2010 (TW) 99133056

(51) Int. Cl. G06F 17/21

(52) U.S. Cl. 715/246

(57) ABSTRACT

A text processing system includes a location module, an obtaining module, a first processing module, a second processing module and a presenting module. The location module determines a text area with a fixed height and a fixed width on a screen. The obtaining module obtains an original text having a plurality of characters with one or more font sizes from a particular source. The first processing module determines presentable text of the original text that the text area can accommodate. The second processing module replaces the last one or more characters of the presentable text with one or more predetermined characters when the presentable text is less than the original text. The presenting module presents the edited presentable text in the text area.

### BACKGROUND

1. Technical Field

The disclosure generally relates to a system and method for processing text in an electronic device.

2. Description of Related Art

A text control, such as a text label or a text widget of a software application, is used to display a text or texts. In most situations, a text area provided by the text control is usually limited to accommodate text with a certain number of characters due to a limit on the size of the text area. If the text area is not able to accommodate all characters of a text, the conventional manner for use by a text control is to automatically cut out and drop the redundant characters. However, a user may not be conscious of this editing, which is an undesirable situation.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a text processing system installed in an electronic device.

FIG. 2 illustrates an exemplary embodiment for calculating the height of a text line.

FIG. 3 illustrates an exemplary embodiment for replacing the last one or more characters of a presentable text with predetermined characters.

FIG. 4 is an operational flow diagram representing an exemplary embodiment for processing text using the text processing system of FIG. 1.

FIG. 5 is an operational flow diagram representing an exemplary embodiment for calculating a maximum of presentable text out of the original text that the text area can accommodate.

FIG. 6 is an operational flow diagram representing an exemplary embodiment for splitting the original text into a plurality of text lines.

FIG. 7 is an operational flow diagram representing an exemplary embodiment for calculating the height of a text line.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

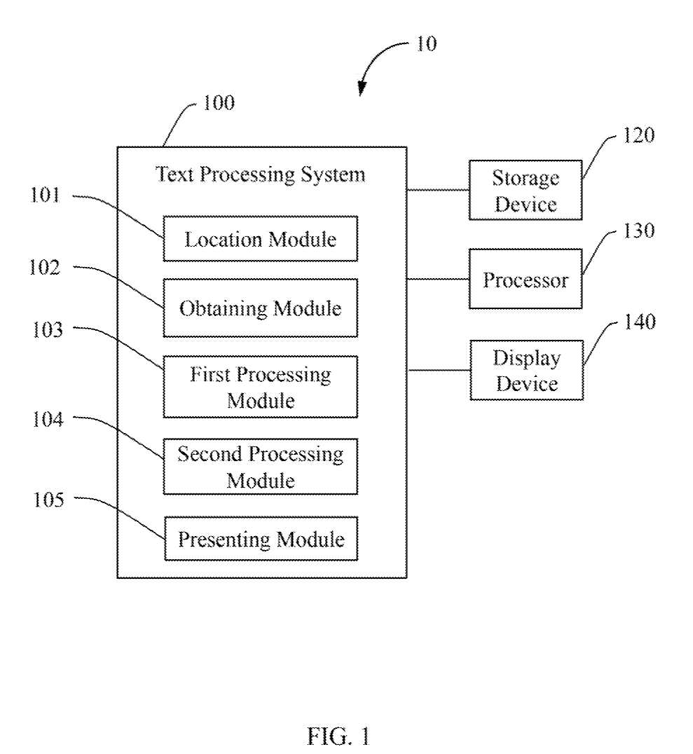

FIG. 1 is a schematic diagram of one embodiment of an electronic device 10. In the embodiment, the electronic device 10 may include a text processing system 100, a storage device 120, at least one processor 130, and a display device 140. The text processing system 100 may display a text in a text area on the screen of the display device 140 of the electronic device 10.

In one embodiment, the storage device 120 may be a magnetic or an optical storage system, such as a hard disk drive, an optical drive, or a tape drive. The storage device 120 also stores text that is intended to be presented in a text area. The display device 140 is configured with a display screen, such as a liquid crystal display (LCD) or a cathode-ray tube (CRT) display.

In one embodiment, the text processing system 100 includes a location module 101, an obtaining module 102, a first processing module 103, a second processing module 104, and a presenting module 105. Each of the modules 101-105 may be a software program including one or more computerized instructions that are stored in the storage device 120 and can be executed by the processor 130.

The location module 101 may determine a text area with a fixed height and a fixed width on a screen of the display device 140. As an example, a rectangle text area might be defined which has a size of 200*300 pixels.

The obtaining module 102 may obtain an original text having a plurality of characters with a one or more font sizes from a particular source. The source may be a database or a text file stored in the storage device 120.

The first processing module 103 may calculate width of each character of the original text based on the one or more font sizes. According to width of the text area and the width of each character, the first processing module 103 may determine the maximum number of characters that a row of text area can accommodate. The first processing module 103 may split the original text into a plurality of text lines according to the maximum number of characters that a row of the text area can accommodate.

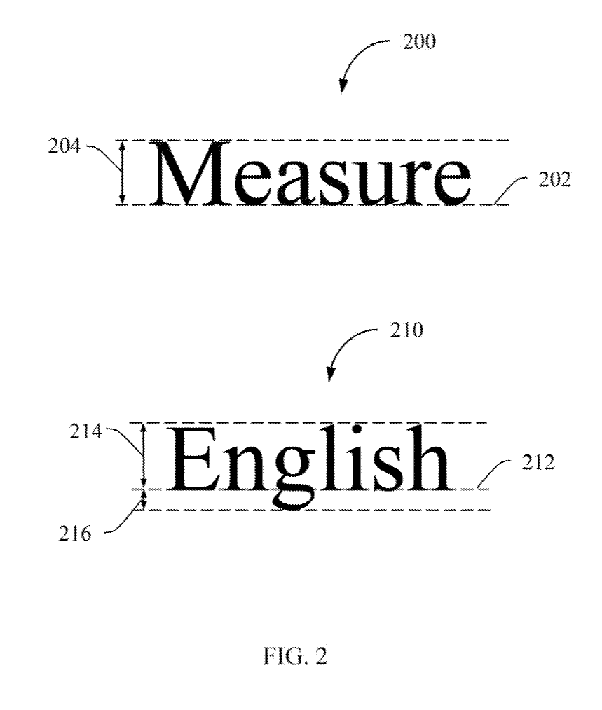

Referring to FIG. 2, in one embodiment, the first processing module 103 calculates the respective heights of a first text line 200 and a second text line 210. As an example, the first text line 200 includes the characters of the word “Measure”, in which all of characters are above a base line 202. The first processing module 103 can determine the top height 204 of the character “M” as the maximum top height among these characters of “Measure”. Since the bottoms of all these characters are on the same level, the first processing module 103 can determine the top height 204 as the height of the first text line 200. The second text line 210 includes the characters of the word “English”, in which all the characters except the letter “g” are above a base line 212. The character “g” has a portion above the base line 212 and a portion under the base line 212. The first processing module 103 can determine the top height 214 of the character “l” as the maximum top height, the bottom height 216 of the character “g” as the maximum bottom height among these characters of “English”. The sum of the top height 214 and the bottom height 216 can be determined as the height of the second text line 210.

The first processing module 103 may determine presentable text lines, total text lines that the text area can accommodate, based on height of the text area and height of each of the plurality of text lines. The first processing module 103 may further determine text contained in the presentable text lines as a presentable text.

When the presentable text is less than the original text, the second processing module 104 may determine the last separating character of the presentable text, and replace one or more characters after the separating character of the presentable text with one or more predetermined characters. A separating character may be a space character or a punctuation character, for example “ . . . ”.

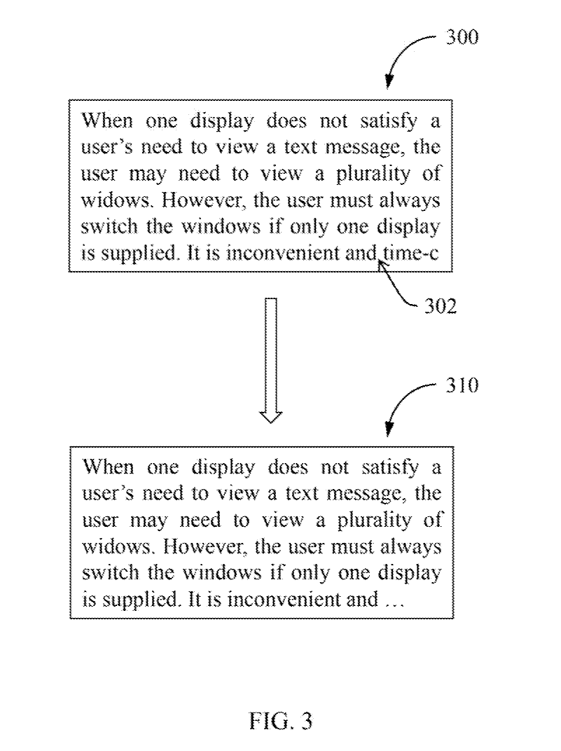

Referring to FIG. 3, in one embodiment the second processing module 104 transforms a text 300 to a presentable text 310. The second processing module 104 finds a space character 302 before the characters “time-c” as the last separating character of the presentable text 300. The second processing module 104 replaces the characters “time-c”, which immediately follow the space character 302, with punctuation character “ . . . ” to imply a cut of text at that point. Thus the text 300 is transformed to the presentable text 310 by the replacement of a few characters.

The presenting module 105 may present the presentable text, such as the presentable text 310 of FIG. 3, in the text area.

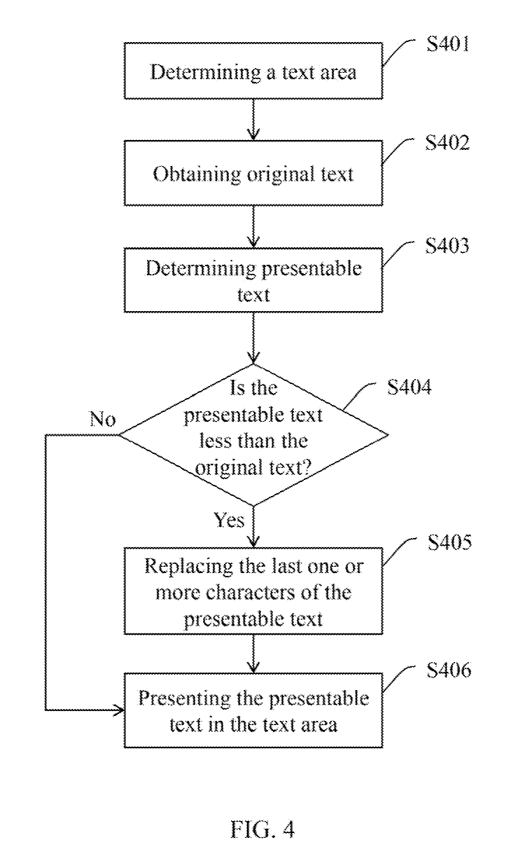

FIG. 4 is a flowchart illustrating one embodiment of a method of processing text. The method can include one or more of the following blocks.

In block S401, the location module 101 determines a text area with a fixed height and a fixed width on a screen of the display device 140.

In block S402, the obtaining module 102 obtains original text having a plurality of characters with one or more font sizes from a particular source.

In block S403, the first processing module 103 determines presentable text of the original text that the text area can accommodate.

In block S404, if the presentable text is less than the original text, the flow goes to block S405, otherwise goes to block S406.

In block S405, the second processing module 104 determines the last separating character of the presentable text, and replaces the one or more characters after the last separating character of the presentable text with one or more predetermined characters.

In block S406, the presenting module 105 presents the presentable text in the text area.

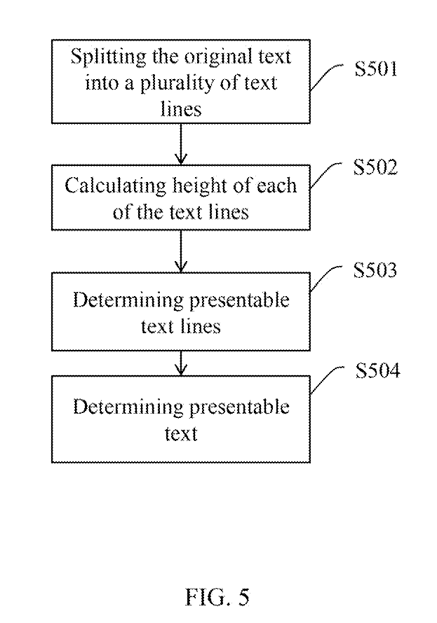

FIG. 5 is a flowchart illustrating one embodiment of a method of determining a presentable text of the original text. The method may include the following blocks.

In block S501, the first processing module 103 splits the original text into a plurality of text lines based on width of the text area and the one or more font sizes.

In block S502, the first processing module 103 calculates height of each of the plurality of text lines.

In block S503, the first processing module 103 determines presentable text lines, total text lines that the text area can accommodate, based on height of the text area and height of each of the plurality of text lines.

In block S504, the first processing module 103 determines text contained in the presentable text lines as presentable text.

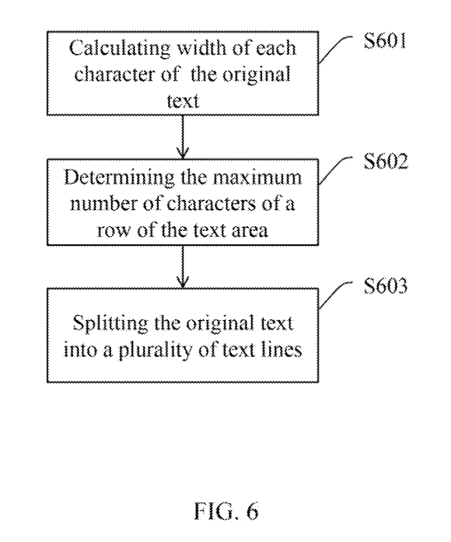

FIG. 6 is a flowchart illustrating one embodiment of a method of splitting the original text into a plurality of text lines. The method may include the following blocks.

In block S601, the first processing module 103 calculates width of each character of the original text based on the relevant font size.

In block S602, the first processing module 103 determines the maximum number of characters that a row of the text area can accommodate based on width of the text area and width of each character.

In block S603, the first processing module 103 splits the original text into a plurality of text lines according to the maximum number of characters that a row of the text area can accommodate.

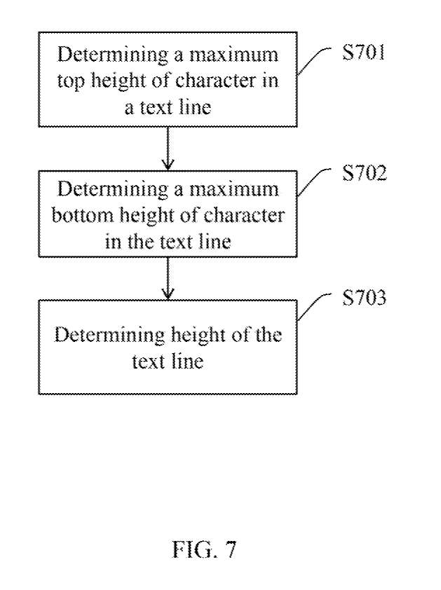

FIG. 7 is a flowchart illustrating one embodiment of a method of calculating height of a text line. The method may include the following blocks.

In block S701, the first processing module 103 determines a maximum top height of character by calculating top height of each character of the text line.

In block S702, the first processing module 103 determines a maximum bottom height of character by calculating bottom height of each character of the text line.

In block S703, the first processing module 103 determines a sum of the maximum top height and the maximum bottom height as height of the text line.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-implemented method of processing text in an electronic device, comprising:
determining a text area with a fixed height and a fixed width on a screen of the electronic device;
obtaining an original text having a plurality of characters with one or more font sizes from a source;
determining a presentable text of the original text that the text area can accommodate;
replacing the last one or more characters of the presentable text with one or more predetermined characters when the presentable text is less than the original text; and
presenting the presentable text in the text area.

2. The method of claim 1, wherein the determining the presentable text of the original text further comprises:
splitting the original text into a plurality of text lines based on width of the text area and the one or more font sizes;
calculating height of each of the plurality of text lines;
deciding total text lines that the text area can accommodate as presentable text lines, based on height of the text area and height of each of the plurality of text lines; and
determining text contained in the presentable text lines as the presentable text.

3. The method of claim 2, wherein the splitting the original text into the plurality of text lines further comprises:
calculating width of each character of the original text based on the one or more font sizes;
determining a maximum number of characters that a row of the text area can accommodate based on width of the text area and width of each character; and
splitting the original text into the plurality of text lines according to the maximum number of characters that the row of the text area can accommodate.

4. The method of claim 2, wherein the calculating height of each of the plurality of text lines further comprises:
obtaining a maximum top height of character by calculating top height of each character of a text line of the plurality of text lines, and a maximum bottom height of character by calculating bottom height of each character of the text line; and
determining a sum of the maximum top height and the maximum bottom height as the height of the text line.

5. The method of claim 1, wherein the replacing the last one or more characters further comprises:
determining a last separating character of the presentable text; and
replacing one or more characters after the last separating character of the presentable text with the one or more predetermined characters.

6. The method of claim 5, wherein the last separating character is a space character or a punctuation character.

7. A system for processing text in an electronic device, comprising:
a location module adapted to determine a text area with a fixed height and a fixed width on a screen of the electronic device;
an obtaining module adapted to obtain an original text having a plurality of characters with one or more font sizes from a source;
a first processing module adapted to determine a presentable text of the original text that the text area can accommodate;
a second processing module adapted to replace the last one or more characters of the presentable text with one or more predetermined characters when the presentable text is less than the original text; and
a presenting module adapted to present the presentable text in the text area.

8. The system of claim 7, wherein the first processing module is further adapted to split the original text into a plurality of text lines based on width of the text area and the one or more font sizes.

9. The system of claim 8, wherein the first processing module is further adapted to calculate height of each of the plurality of text lines.

10. The system of claim 9, wherein the first processing module is further adapted to determine presentable text lines, total text lines that the text area can accommodate, based on height of the text area and height of each of the plurality of text lines, and determine text contained by the presentable text lines as the presentable text.

11. The system of claim 8, wherein the first processing module is further adapted to calculate width of each character of the original text based on the one or more font sizes.

12. The system of claim 11, wherein the first processing module is further adapted to determine a maximum number of characters that a row of the text area can accommodate based on width of the text area and width of each character, and split the original text into the plurality of text lines according to the maximum number of characters that the row of the text area can accommodate.

13. The system of claim 8, wherein the first processing module is further adapted to determining a maximum top height of character by calculating top height of each character of a text line of the plurality of text lines, a maximum bottom height of character by calculating bottom height of each character of the text line, and determine a sum of the maximum top height and the maximum bottom height as height of the text line.

14. The system of claim 7, wherein the second processing module is further adapted to, when the presentable text is less than the original text, determine a last separating character of the presentable text, and replace one or more characters after the last separating character of the presentable text with the one or more predetermined characters.

15. The system of claim 14, wherein the last separating character is a space character or a punctuation character.

16. A computer-implemented method of processing text in an electronic device, comprising:
providing a location module, an obtaining module, a first processing module, a second processing module, and a presenting module;
determining a text area with a fixed height and a fixed width on a screen of the electronic device by the location module;
obtaining an original text having a plurality of characters with one or more font sizes from a source by the obtaining module;
determining a presentable text of the original text that the text area can accommodate by the first processing module;
replacing the last one or more characters of the presentable text with one or more predetermined characters when the presentable text is less than the original text by the second processing module; and
presenting the presentable text in the text area by the presenting module.
